(19) United States
(12) Patent Application Publication
(10) Pub. No.: US 2026/0245522 A1
(43) Pub. Date: Aug. 20, 2026

(54) PIXEL CIRCUIT, METHOD FOR DRIVING THE SAME, AND DISPLAY PANEL

(71) Applicant: XIAMEN TIANMA DISPLAY TECHNOLOGY CO., LTD., Xiamen (CN)

(72) Inventors: Xuehuan FANG, Xiamen (CN); Yana GAO, Xiamen (CN); Xingyao ZHOU, Xiamen (CN); Zhiqiang XIA, Xiamen (CN); Kang YANG, Xiamen (CN)

(21) Appl. No.: 19/646,698

(22) Filed: Apr. 14, 2026

(30) Foreign Application Priority Data
Apr. 15, 2025 (CN) 202510468003.6

(51) Int. Cl. G09G 3/3233

(52) U.S. Cl. CPC G09G 3/3233; G09G 2300/043; G09G 2300/0819; G09G 2310/08; G09G 2320/0233

(57) ABSTRACT

Provided are a pixel circuit, a method for driving the same, and a display panel. In the pixel circuit, a driving transistor's first electrode, gate and second electrode respectively connected to first, second and third nodes. A power supply voltage writing module is connected to a power supply signal line and first node. A threshold compensation module is connected to the first and second nodes. A data writing module is connected to a data signal line and the third node. An auxiliary threshold compensation module is coupled to a first signal line and third node. The threshold compensation module is turned on in a threshold compensation phase and a subsequent data writing phase. The data writing module is turned on in the data writing phase. The auxiliary threshold compensation module transmits a first voltage on the first signal line to the third node during or before the threshold compensation phase.

### CROSS-REFERENCE TO RELATED APPLICATION

The present disclosure claims priority to Chinese Patent Application No. 202510468003.6, filed on Apr. 15, 2025, the content of which is incorporated herein by reference in its entirety.

### TECHNICAL FIELD

The present disclosure relates to the field of display technologies, and in particular, to a pixel circuit, a method for driving the same, and a display panel.

### BACKGROUND

In the field of display technologies, a display panel is usually provided with a pixel circuit to drive a light-emitting device to emit light. A threshold voltage of a driving transistor in the pixel circuit can have an important influence on the light-emitting effect of the light-emitting device.

### SUMMARY

In view of the above, embodiments of the present disclosure provide a pixel circuit, a method for driving the same, and a display panel, to solve the above problem.

In a first aspect, an embodiment of the present disclosure provides a pixel circuit applied to a display panel, where the pixel circuit includes:
a driving transistor configured to generate a light-emitting driving current and having a first electrode electrically connected to a first node, a gate electrically connected to a second node, and a second electrode electrically connected to a third node, where the driving transistor is an N-type transistor;
a power supply voltage writing module having an input terminal electrically connected to a power supply signal line and an output terminal electrically connected to the first node;
a threshold compensation module having an input terminal electrically connected to the first node and an output terminal electrically connected to the second node;
a data writing module having an input terminal electrically connected to a data signal line and an output terminal electrically connected to the third node;
an auxiliary threshold compensation module having an input terminal electrically connected to a first signal line and an output terminal coupled to the third node, where the auxiliary threshold compensation module is configured to transmit a first voltage on the first signal line to the third node;
where an operation process of the pixel circuit includes a threshold compensation phase and a data writing phase performed after the threshold compensation phase; and
where the threshold compensation module is turned on in the threshold compensation phase and the data writing phase, the data writing module is turned on in the data writing phase, and the auxiliary threshold compensation module transmits the first voltage to the third node during or before the threshold compensation phase.

In a second aspect, based on the same inventive concept, an embodiment of the present disclosure provides another pixel circuit applied to a display panel, where the pixel circuit includes:
a driving transistor configured to generate a light-emitting driving current and having a first electrode electrically connected to a first node, a gate electrically connected to a second node, and a second electrode electrically connected to a third node, where the driving transistor is an N-type transistor;
a first transistor having a first electrode electrically connected to a power supply signal line and a second electrode electrically connected to the first node;
a second transistor having a first electrode electrically connected to the first node and a second electrode electrically connected to the second node;
a third transistor having a first electrode electrically connected to a data signal line and a second electrode electrically connected to the third node;
a fourth transistor having a first electrode electrically connected to a first signal line and a second electrode coupled to the third node, where the fourth transistor is configured to transmit a first voltage on the first signal line to the third node;
where an operation process of the pixel circuit includes a threshold compensation phase and a data writing phase performed after the threshold compensation phase; and
where the second transistor is turned on in the threshold compensation phase and the data writing phase, the third transistor is turned on in the data writing phase, and the fourth transistor transmits the first voltage to the third node during or before the threshold compensation phase.

In a third aspect, based on the same inventive concept, an embodiment of the present disclosure provides a method for driving a pixel circuit, where the pixel circuit includes:
a driving transistor configured to generate a light-emitting driving current and having a first electrode electrically connected to a first node, a gate electrically connected to a second node, and a second electrode electrically connected to a third node, where the driving transistor is an N-type transistor;
a power supply voltage writing module having an input terminal electrically connected to a power supply signal line and an output terminal electrically connected to the first node;
a threshold compensation module having an input terminal electrically connected to the first node and an output terminal electrically connected to the second node;
a data writing module having an input terminal electrically connected to a data signal line and an output terminal electrically connected to the third node;
an auxiliary threshold compensation module having an input terminal electrically connected to a first signal line and an output terminal coupled to the third node, where the auxiliary threshold compensation module is configured to transmit a first voltage on the first signal line to the third node; and
where an operation process of the pixel circuit includes a threshold compensation phase and a data writing phase performed after the threshold compensation phase; the method includes:
turning on the threshold compensation module in the threshold compensation phase;
turning on the threshold compensation module and the data writing module in the data writing phase; and
turning on the auxiliary threshold compensation module in and/or before the threshold compensation phase.

In a fourth aspect, based on the same inventive concept, an embodiment of the present disclosure provides a display panel, including the pixel circuit as provided in the first aspect or the second aspect.

### BRIEF DESCRIPTION OF DRAWINGS

In order to more clearly illustrate technical solutions of embodiments of the present disclosure, the accompanying drawings required to be used in the embodiments will be briefly described below. Apparently, the accompanying drawings described below are merely some embodiments of the present disclosure, and other drawings may be obtained by those of ordinary skill in the art according to these drawings without any creative efforts.

FIG. 1 is a schematic diagram of a pixel circuit in the related art.

FIG. 2 is a timing diagram of the pixel circuit shown in FIG. 1.

FIG. 3 is a schematic diagram of a display panel according to an embodiment of the present disclosure.

FIG. 4 is a schematic diagram of a pixel circuit according to an embodiment of the present disclosure.

FIG. 5 is a schematic diagram of the pixel circuit shown in FIG. 4.

FIG. 6 is a timing diagram of the pixel circuit shown in FIG. 5.

FIG. 7 is another timing diagram of the pixel circuit shown in FIG. 5.

FIG. 8 is a schematic diagram of another pixel circuit according to an embodiment of the present disclosure.

FIG. 9 is a schematic diagram of the pixel circuit shown in FIG. 8.

FIG. 10 is a timing diagram of the pixel circuit shown in FIG. 9.

FIG. 11 is another timing diagram of the pixel circuit shown in FIG. 9.

FIG. 12 is a schematic diagram of another pixel circuit according to an embodiment of the present disclosure.

FIG. 13 is a schematic diagram of the pixel circuit shown in FIG. 12.

FIG. 14 is a timing diagram of the pixel circuit shown in FIG. 13.

FIG. 15 is a schematic diagram of another pixel circuit according to an embodiment of the present disclosure.

FIG. 16 is a schematic diagram of the pixel circuit shown in FIG. 15.

FIG. 17 is a timing diagram of the pixel circuit shown in FIG. 16.

FIG. 18 is another timing diagram of the pixel circuit shown in FIG. 5.

FIG. 19 is a schematic diagram of another pixel circuit according to an embodiment of the present disclosure.

FIG. 20 is a flowchart of a method for driving a pixel circuit according to an embodiment of the present disclosure.

FIG. 21 is a flowchart of a method for driving another pixel circuit according to an embodiment of the present disclosure.

### DESCRIPTION OF EMBODIMENTS

In order to better understand technical solutions of the present disclosure, embodiments of the present disclosure are described in detail below in conjunction with the drawings.

It should be clear that the described embodiments are merely a part of the embodiments of the present disclosure rather than all of the embodiments. All other embodiments obtained by those of ordinary skill in the art without creative efforts based on the embodiments of the present disclosure shall fall within the scope of protection of the present disclosure.

The terms used in the embodiments of the present disclosure are only for the purpose of describing specific embodiments and are not intended to limit the present disclosure. The singular forms “a/an” “said” and “the” used in the embodiments of the present disclosure and the appended claims are also intended to include plural forms, unless the context clearly indicates otherwise.

It should be understood that the term “and/or” used herein is merely an association relationship describing associated objects, indicating that there can be three relationships. For example, A and/or B can represent the following three situations: A exists alone, both A and B exist simultaneously, and B exists alone. In addition, the character “/” herein generally indicates an “or” relationship between the associated objects before and after it.

Various modifications and changes can be made to the present disclosure without departing from the spirit and scope of the disclosure, which is obvious to those of skill in the art. Therefore, the present disclosure intends to cover the modifications and changes of the present disclosure that fall within the scope of the corresponding claims (claimed technical solutions) and their equivalents. It should be noted that the implementations provided in the embodiments of the present disclosure can be combined with each other without contradiction.

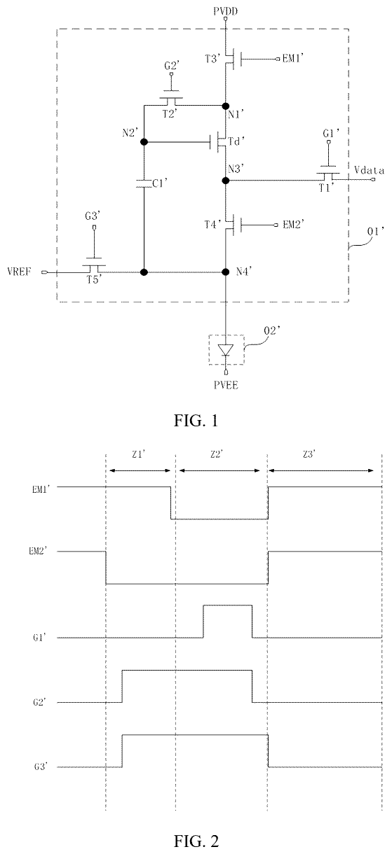

FIG. 1 is a schematic diagram of a pixel circuit in the related art, and FIG. 2 is a timing diagram of the pixel circuit shown in FIG. 1.

In the related art, as shown in FIG. 1, the pixel circuit 01′ includes a driving transistor Td′, a data writing transistor T1′, a first reset transistor T2′, a power supply voltage writing transistor T3′, a light-emitting control transistor T4′, a second reset transistor T5′, and a storage capacitor C1′. The driving transistor Td′ has a first electrode electrically connected to a first node N1′, a gate electrically connected to a second node N2′, and a second electrode electrically connected to a third node N3′.

The driving transistor Td′, the data writing transistor T1′, the first reset transistor T2′, the power supply voltage writing transistor T3′, the light-emitting control transistor T4′, and the second reset transistor T5′ are all N-type transistors (turned on at a high level, and turned off at a low level).

The data writing transistor T1′ has a first electrode receiving a data voltage Vdata, a second electrode electrically connected to the third node N3′, and a gate electrically connected to a first scan line G1′. The first reset transistor T2′ has a first electrode electrically connected to the first node N1′, a second electrode electrically connected to the second node N2′, and a gate electrically connected to the second scan line G2′.

The power supply voltage writing transistor T3′ has a first electrode receiving a first power supply voltage PVDD, a second electrode electrically connected to the first node N1′, and a gate electrically connected to a first light-emitting control signal line EM1′. The light-emitting control transistor T4′ has a first electrode electrically connected to the third node N3′, a second electrode electrically connected to a fourth node N4′, and a gate electrically connected to a second light-emitting control signal line EM2′. The fourth node N4′ is electrically connected to an anode of a light-emitting device 02′, and a cathode of the light-emitting device 02′ receives a second power supply voltage PVEE.

The second reset transistor T5′ has a first electrode receiving an anode reset voltage VREF, a second electrode electrically connected to the fourth node N4′, and a gate electrically connected to the third scan line G3′. The storage capacitor C1′ has one plate electrically connected to the second node N2′ and the other plate electrically connected to the fourth node N4′.

As shown in conjunction with FIG. 2, an operation process of the pixel circuit 01′ includes a reset phase Z1′, a data writing phase Z2′, and a light-emitting phase Z3′ which are sequentially performed.

In the reset phase Z1′, the first light-emitting control signal line EM1′ and the second scan line G2′ each transmit a high-level signal, the power supply voltage writing transistor T3′ and the first reset transistor T2′ are turned on, and the first power supply voltage PVDD is transmitted to the second node N2′ through the power supply voltage writing transistor T3′ and the first reset transistor T2′, so as to complete the reset of the gate of the driving transistor Td′. At the same time, the third scan line G3′ transmits a high-level signal, the second reset transistor T5′ is turned on, and the anode reset voltage VREF is transmitted to the fourth node N4′ through the second reset transistor T5′, so as to reset the anode of the light-emitting device 02′.

In the data writing phase Z2′, the first scan line G1′ and the second scan line G2′ each transmit a high-level signal, the data writing transistor T1′ and the first reset transistor T2′ are turned on, and the data voltage Vdata can be transmitted to the second node N2′ through the data writing transistor T1′, the driving transistor Td′, and the first reset transistor T2′, and at the same time, a threshold voltage Vth of the driving transistor Td′ is compensated to the second node N2′. That is, the data voltage Vdata and the threshold voltage Vth of the driving transistor Td′ can be transmitted to the gate of the driving transistor Td′.

At the same time, the third scan line G3′ transmits a high-level signal, the second reset transistor T5′ is maintained in a turn-on state, and the anode reset voltage VREF is transmitted to the fourth node N4′ through the second reset transistor T5′, so as to continuously reset the anode of the light-emitting device 02′.

In the light-emitting phase Z3′, the first light-emitting control signal line EM1′ and the second light-emitting control signal line EM2′each transmit a high-level signal, the power supply voltage writing transistor T3′ and the light-emitting control transistor T4′ are turned on, and a light-emitting current generated by the driving transistor Td′ is transmitted to the light-emitting device 02′, so as to drive the light-emitting device 02′ to emit light.

The inventors of the present disclosure have found through research that in the related art, it can be known from the operation process of the pixel circuit 01′ that when the threshold voltage Vth of the driving transistor Td′ is compensated to the gate thereof, a compensation duration is limited by a writing duration of the data voltage Vdata, which results in that the compensation duration of the threshold voltage Vth of the driving transistor Td′ is shorter and smaller than the scan duration of a row of pixels, whereby in turn incomplete compensation of the threshold voltage Vth of the driving transistor Td′ is caused, and the threshold voltage Vth of the driving transistor Td′ will affect the magnitude of a light-emitting driving current. Moreover, since the threshold voltages of different driving transistors Td′ are usually different, this results in poor brightness uniformity of the light-emitting devices 02′ driven by different pixel circuits 01′.

Especially when a mobility of the driving transistor Td′ is relatively low, the compensation effect of the threshold voltage Vth of the driving transistor Td′ is poor, and the impact on the brightness uniformity of the light-emitting device is particularly severe.

In view of this, the inventors of the present disclosure provide a solution to solve the problems existing in the related art.

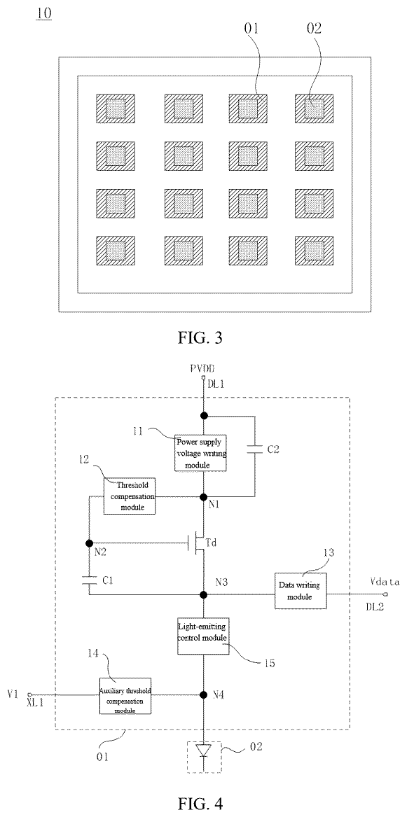

FIG. 3 is a schematic view of a display panel according to an embodiment of the present disclosure, and FIG. 4 is a schematic diagram of a pixel circuit according to an embodiment of the present disclosure.

An embodiment of the present disclosure provides a pixel circuit 01 applied to the display panel 10. As shown in FIG. 3, the display panel 10 further includes a light-emitting device 02, and the pixel circuit 01 is electrically connected to the light-emitting device 02 to drive the light-emitting device 02 to emit light.

As shown in FIG. 4, the pixel circuit 01 includes a driving transistor Td, a power supply voltage writing module 11, a threshold compensation module 12, a data writing module 13, and an auxiliary threshold compensation module 14. The driving transistor Td is configured to generate a light-emitting driving current. The driving transistor Td has a first electrode electrically connected to a first node N1, a gate electrically connected to a second node N2, and a second electrode electrically connected to a third node N3. The driving transistor Td may be an N-type transistor. As an example, the driving transistor Td includes an oxide.

The power supply voltage writing module 11 has an input terminal electrically connected to a power supply signal line DL1 and an output terminal electrically connected to the first node N1. The power supply signal line DL1 is configured to transmit a power supply voltage PVDD to the power supply voltage writing module 11.

The threshold compensation module 12 has an input terminal electrically connected to the first node N1 and an output terminal electrically connected to the second node N2. The data writing module 13 has an input terminal electrically connected to a data signal line DL2 and an output terminal electrically connected to the third node N3. The data signal line DL2 is configured to transmit a data voltage Vdata to the data writing module 13.

The auxiliary threshold compensation module 14 has an input terminal electrically connected to a first signal line XL1 and an output terminal coupled to the third node N3. The auxiliary threshold compensation module 14 is configured to transmit a first voltage V1 on the first signal line XL1 to the third node N3.

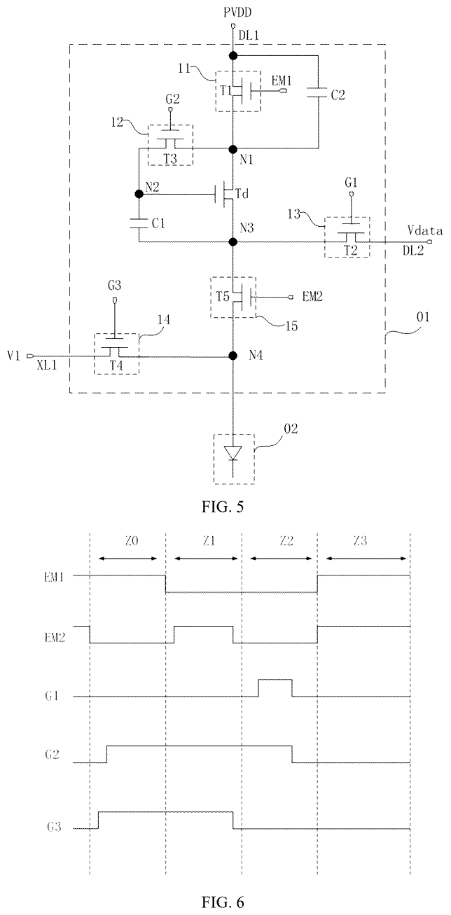

As shown in conjunction with FIGS. 5 and 6, where FIG. 5 is a schematic diagram of the pixel circuit shown in FIG. 4, and FIG. 6 is a timing diagram of the pixel circuit shown in FIG. 5, an operation process of the pixel circuit 01 includes a threshold compensation phase Z1 and a data writing phase Z2 performed after the threshold compensation phase Z1.

The threshold compensation module 12 is turned on in the threshold compensation phase Z1 and the data writing phase Z2. The data writing module 13 is turned on in the data writing phase Z2. The auxiliary threshold compensation module 14 transmits the first voltage V1 to the third node N3 during or before the threshold compensation phase Z1.

In the embodiment of the present disclosure, the threshold compensation phase Z1 and the data writing phase Z2 may be separately performed, making the auxiliary threshold compensation module 14 transmit the first voltage V1 to the third node N3 during or before the threshold compensation phase Z1 is beneficial for the first voltage V1 to be transmitted to the gate of the driving transistor Td through the driving transistor Td and the turned-on threshold compensation module 12 in the threshold compensation phase Z1, thereby compensating a threshold voltage of the driving transistor Td to the gate of the driving transistor Td.

In this way, a compensation duration of the threshold voltage of the driving transistor Td is no longer limited by a writing duration of the data voltage Vdata, which is beneficial to completely compensating the threshold voltage of the driving transistor Td in the operation process of the pixel circuit 01, thereby being beneficial to eliminating the influence of the threshold voltage of the driving transistor Td on the light-emitting driving current to a relatively large extent, and in turn being beneficial to improving the brightness uniformity of different light-emitting devices.

Optionally, still referring to FIGS. 4 and 5, the pixel circuit 01 further includes a first capacitor C1 and a second capacitor C2. The first capacitor C1 has one plate electrically connected to the second node N2 and the other plate electrically connected to the third node N3. The second capacitor C2 has one plate electrically connected to the power supply signal line DL1 and the other plate electrically connected to the first node N1.

Based on this arrangement, as shown in conjunction with FIG. 6, in the data writing phase Z2, the data writing module 13 and the threshold compensation module 12 are turned on, the first capacitor C1 and the second capacitor C2 are electrically connected through the threshold compensation module 12, and the data voltage Vdata is transmitted to the third node N3 through the turned-on data writing module 13 and is transmitted to the second node N2 through the coupling effect of the first capacitor C1 and the second capacitor C2, thereby enabling the data voltage Vdata to be written into the gate of the driving transistor Td.

As an example, as shown in FIG. 5, the power supply voltage writing module 11 includes a power supply voltage writing transistor T1. The power supply voltage writing transistor T1 has a first electrode electrically connected to the power supply signal line DL1, a second electrode electrically connected to the first node N1, and a gate electrically connected to the first light-emitting control signal line EM1. The data writing module 13 includes a data writing transistor T2. The data writing transistor T2 has a first electrode electrically connected to the data signal line DL2, a second electrode electrically connected to the third node N3, and a gate electrically connected to a first scan line G1.

The threshold compensation module 12 includes a threshold compensation transistor T3. The threshold compensation transistor T3 has a first electrode electrically connected to the first node N1, a second electrode electrically connected to the second node N2, and a gate electrically connected to a second scan line G2. The auxiliary threshold compensation module 14 includes an auxiliary transistor T4. The auxiliary transistor T4 has a first electrode electrically connected to the first signal line XL1, a second electrode coupled to the third node N3, and a gate electrically connected to a third scan line G3.

As an example, as shown in FIG. 5, the power supply voltage writing transistor T1, the data writing transistor T2, the threshold compensation transistor T3 and the auxiliary transistor T4 are all N-type transistors (turned on at a high level, and turned off at a low level).

As shown in conjunction with FIGS. 5 and 6, the operation process of the pixel circuit 01 further includes a reset phase Z0, which is performed before the threshold compensation phase Z1.

The power supply voltage writing module 11 and the threshold compensation module 12 are turned on in the reset phase Z0.

Specifically, as shown in conjunction with FIGS. 5 and 6, in the reset phase Z0, the first light-emitting control signal line EM1 and the second scan line G2 each transmit a high-level signal, the power supply voltage writing transistor T1 and the threshold compensation transistor T3 are turned on, and the power supply voltage PVDD on the power supply signal line DL1 can be transmitted to the first node N1 through the turned-on power supply voltage writing transistor T1 and transmitted to the second node N2 through the turned-on threshold compensation transistor T3, to complete the reset of the gate of the driving transistor Td.

Optionally, in the reset phase Z0, a turn-on period of the power supply voltage writing module 11 at least partially overlaps with a turn-on period of the threshold compensation module 12. That is, a period in which the first light-emitting control signal line EM1 transmits the high level at least partially overlaps with a period in which the second scan line G2 transmits the high level.

This arrangement is beneficial to increasing the accuracy of transmitting the power supply voltage PVDD to the second node N2, thereby being beneficial to improving the reliability of resetting the gate of the driving transistor Td.

In an embodiment of the present disclosure, as shown in FIG. 4, the pixel circuit 01 further includes a light-emitting control module 15. The light-emitting control module 15 has an input terminal electrically connected to the third node N3 and an output terminal electrically connected to the fourth node N4. The fourth node N4 is electrically connected to a first electrode of the light-emitting device 02. The light-emitting device 02 may be an organic light-emitting diode. The first electrode of the light-emitting device 02 may be an anode thereof.

As an example, as shown in FIG. 5, the light-emitting control module15 includes a light-emitting control transistor T5. The light-emitting control transistor T5 has a first electrode electrically connected to the third node N3, a second electrode electrically connected to the fourth node N4, and a gate electrically connected to a second light-emitting control signal line EM2. The light-emitting control transistor T5 may be an N-type transistor (turned on at a high level, and turned off at a low level).

The output terminal of the auxiliary threshold compensation module 14 is electrically connected to the fourth node N4. The auxiliary threshold compensation module 14 is turned on in the reset phase Z0 and/or in the threshold compensation phase Z1. The first voltage V1 is further configured to reset the first electrode of the light-emitting device 02. That is, the first voltage V1 may also be used as a reset voltage for resetting the first electrode of the light-emitting device 02. In at least one of the reset phase Z0 and the threshold compensation phase Z1, the first voltage V1 can be transmitted to the fourth node N4 through the turned-on auxiliary threshold compensation module 14 to complete the reset of the first electrode of the light-emitting device 02.

As an example, as shown in FIGS. 5 and 6, in both the reset phase Z0 and the threshold compensation phase Z1, the third scan line G3 transmits a high-level signal. The auxiliary transistor T4 is turned on in both the reset phase Z0 and the threshold compensation phase Z1. The first voltage V1 is transmitted to the fourth node N4 through the turned-on auxiliary transistor T4 to reset the first electrode of the light-emitting device 02.

In the reset phase Z0 and the threshold compensation phase Z1, a turn-on period of the light-emitting control module 15 at least partially overlaps with a turn-on period of the auxiliary threshold compensation module 14.

In the embodiment of the present disclosure, in the reset phase Z0 and the threshold compensation phase Z1, the turn-on period of the light-emitting control module 15 is set to at least partially overlap with the turn-on period of the auxiliary threshold compensation module 14, such that in and/or before the threshold compensation phase Z1, the first voltage V1 can be transmitted to the third node N3 through the turned-on auxiliary threshold compensation module 14 and the light-emitting control module 15, thereby being beneficial to transmission to the second node N2 through the driving transistor Td and the threshold compensation module 12 in the threshold compensation phase Z1, to compensate the threshold voltage of the driving transistor Td to the gate of the driving transistor Td.

It should be noted that when the turn-on period of the light-emitting control module 15 overlaps with the turn-on period of the auxiliary threshold compensation module 14 in the reset phase Z0, the turn-on period of the light-emitting control module 15 does not overlap with the turn-on period of the power supply voltage writing module 11 in the reset phase Z0, so as to avoid causing the light-emitting device 02 to emit light abnormally.

As an example, as shown in FIGS. 5 and 6, the turn-on period of the light-emitting control module 15 overlaps with the turn-on period of the auxiliary threshold compensation module 14 in the threshold compensation phase Z1, and does not overlap in the reset phase Z0. In this way, the first voltage V1 can be transmitted to the third node N3 through the auxiliary threshold compensation module 14 and the light-emitting control module 15 in the threshold compensation phase Z1, and in turn transmitted to the second node N2 through the driving transistor Td and the threshold compensation module 12, so as to compensate the threshold voltage of the driving transistor Td to the gate of the driving transistor Td. At the same time, in the reset phase Z0, the light-emitting control module 15 may be kept in a turn-off state, which is beneficial to reducing the driving complexity of the pixel circuit 01.

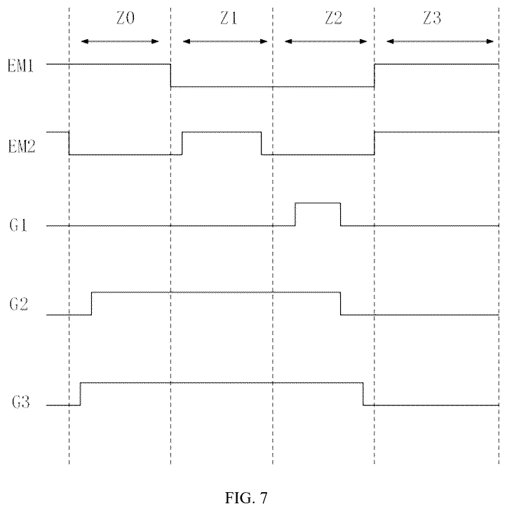

In an implementation of the embodiment of the present disclosure, as shown in conjunction with FIGS. 5 and 7, where FIG. 7 is another timing diagram of the pixel circuit shown in FIG. 5, the auxiliary threshold compensation module 14 is turned on in the reset phase Z0, the threshold compensation phase Z1, and the data writing phase Z2, and the light-emitting control module 15 is turned off in the data writing phase Z2.

In this way, the first voltage V1 can be transmitted to the fourth node N4 in the reset phase Z0, the threshold compensation phase Z1, and the data writing phase Z2, which is beneficial to increasing the reset duration of the first voltage V1 on the first electrode of the light-emitting device 02, thereby being beneficial to improving the reset effect of the first voltage V1 on the first electrode of the light-emitting device 02.

At the same time, making the light-emitting control module15 turned off in the data writing phase Z2 can prevent the data voltage Vdata from being written into the fourth node N4, which could otherwise cause the light-emitting device 02 to emit light abnormally.

To facilitate understanding of the technical solutions of the present disclosure, the operation process of the pixel circuit 01 is described below in conjunction with FIGS. 5 and 7. The operation process of the pixel circuit 01 includes a reset phase Z0, a threshold compensation phase Z1, a data writing phase Z2 and a light-emitting phase Z3 that are sequentially performed.

In the reset phase Z0, the third scan line G3 transmits a high-level signal, the auxiliary transistor T4 is turned on, the first voltage V1 is transmitted to the fourth node N4 to reset the first electrode of the light-emitting device 02, and a potential of the fourth node N4 is V1. The first light-emitting control signal line EM1 and the second scan line G2 each transmit a high-level signal, the power supply voltage writing transistor T1 and the threshold compensation transistor T3 are turned on, the power supply voltage PVDD is transmitted to the first node N1 and the second node N2 to reset the gate of the driving transistor Td, and a potential of the first node N1 and a potential of the second node N2 are both PVDD.

In the threshold compensation phase Z1, the first light-emitting control signal line EM1 transmits a low-level signal, the power supply voltage writing transistor T1 is turned off. The third scan line G3, the second light-emitting control signal line EM2, and the second scan line G2 each transmit a high-level signal. The auxiliary transistor T4, the light-emitting control transistor T5, and the threshold compensation transistor T3 are turned on. The potential of the fourth node N4 and a potential of the third node N3 are V1. Since the first voltage V1 is usually much smaller than the power supply voltage PVDD, at this time, the driving transistor Td is turned on, and the first voltage V1 is written into the first node N1 and the second node N2 until the potentials of the first node N1 and the second node N2 are both V1 +Vth, and the driving transistor Td is turned off. Where Vth is the threshold voltage of the driving transistor Td.

In the data writing phase Z2, the first light-emitting control signal line EM1 and the second light-emitting control signal line EM2 each transmit a low-level signal, and the power supply voltage writing transistor T1 and the light-emitting control transistor T5 are turned off. The first scan line G1 and the second scan line G2 each transmit a high-level signal. The data writing transistor T2 and the threshold compensation transistor T3 are turned on. The data voltage Vdata is transmitted to the third node N3 through the turned-on data writing transistor T2. The potential of the third node N3 jumps from V1 to Vdata. Due to the coupling effect of the first capacitor C1 and the second capacitor C2, the potentials of the first node N1 and the second node N2 become V1+Vth+(Vdata−V1)*C2/(C1+C2). Here, C1 is a capacitance of the first capacitor C1, and C2 is a capacitance of the second capacitor C2. At this time, a gate-source voltage difference Vgs of the driving transistor Td =the potential of the second node N2—the potential of the third node N3=(V1−Vdata)*C1/(C1+C2)+Vth.

At the same time, the third scan line G3 transmits a high-level signal, the auxiliary transistor T4 is turned on, the potential of the fourth node N4 is V1, and the first electrode of the light-emitting device 02 is continuously reset.

In the light-emitting phase Z3, the first scan line G1, the second scan line G2, and the third scan line G3 each transmit a low-level signal. The data writing transistor T2, the threshold compensation transistor T3, and the auxiliary transistor T4 are all turned off. The first light-emitting control signal line EM1 and the second light-emitting control signal line EM2 each transmit a high-level signal. The power supply voltage writing transistor T1 and the light-emitting control transistor T5 are turned on. The light-emitting driving current generated by the driving transistor Td is transmitted to the light-emitting device 02 to drive the light-emitting device 02 to emit light. At this time, the light-emitting driving current IO=K*(Vgs−Vth)\hat{ }2=K*(V1−Vdata)*C1/(C1+C2))\hat{ }2. Where, K is a structural parameter, and Vgs is the gate-source voltage difference of the driving transistor Td.

It can be known from the operation process of the pixel circuit 01 that the threshold voltage Vth of the driving transistor Td no longer affects the magnitude of the light-emitting driving current generated by the driving transistor Td, which is beneficial to improving the brightness uniformity of different light-emitting devices 02.

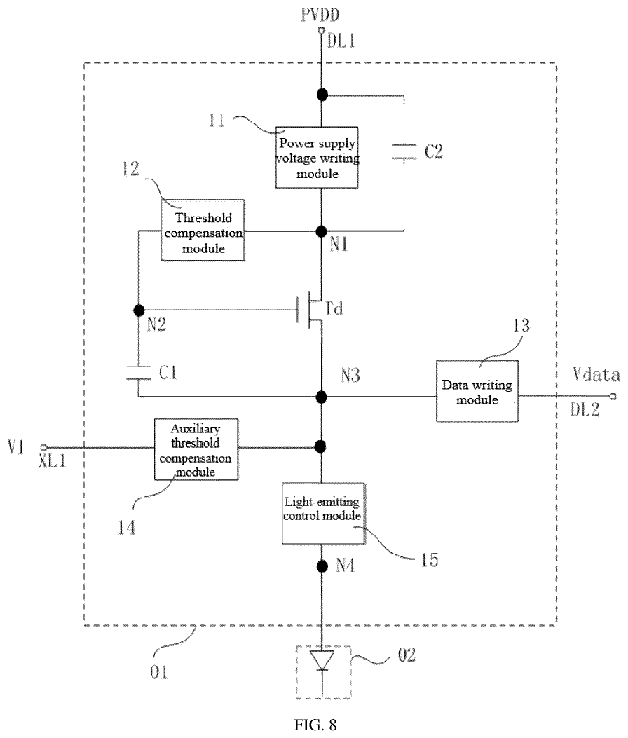

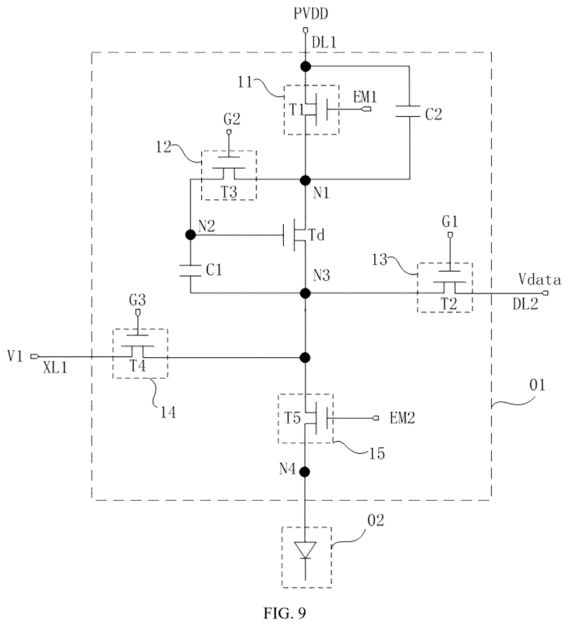

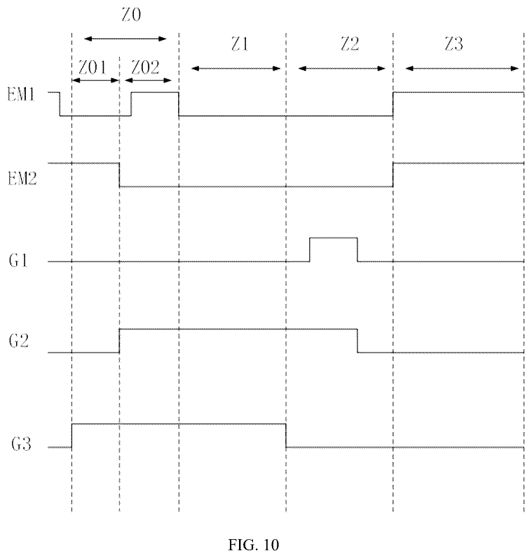

FIG. 8 is a schematic view of another pixel circuit according to an embodiment of the present disclosure, FIG. 9 is a schematic diagram of the pixel circuit shown in FIG. 8, and FIG. 10 is a timing diagram of the pixel circuit shown in FIG. 9.

In an embodiment of the present disclosure, as shown in FIGS. 8 and 9, the pixel circuit 01 further includes a light-emitting control module 15. The light-emitting control module 15 has an input terminal electrically connected to the third node N3 and an output terminal electrically connected to the fourth node N4. The fourth node N4 is electrically connected to the first electrode of the light-emitting device 02. The light-emitting device 02 may be an organic light-emitting diode. The first electrode of the light-emitting device 02 may be an anode thereof.

As an example, as shown in FIG. 9, the light-emitting control module15 includes a light-emitting control transistor T5. The light-emitting control transistor T5 has a first electrode electrically connected to the third node N3, a second electrode electrically connected to the fourth node N4, and a gate electrically connected to a second light-emitting control signal line EM2. The light-emitting control transistor may be an N-type transistor (turned on at a high level, and turned off at a low level).

The output terminal of the auxiliary threshold compensation module 14 is electrically connected to the third node N3. The auxiliary threshold compensation module 14 is turned on in the reset phase Z0 and/or in the threshold compensation phase Z1. The first voltage V1 is further configured to reset the first electrode of the light-emitting device 02. That is, the first voltage V1 can also be used as a reset voltage for resetting the first electrode of the light-emitting device 02.

As shown in conjunction with FIGS. 9 and 10, in the reset phase Z0 and the threshold compensation phase Z1, a turn-on period of the light-emitting control module 15 at least partially overlaps with a turn-on period of the auxiliary threshold compensation module 14, and the turn-on period of the light-emitting control module 15 does not overlap with an turn-on period of the power supply voltage writing module 11.

In the embodiment of the present disclosure, in the reset phase Z0 and the threshold compensation phase Z1, the turn-on period of the light-emitting control module 15 is set to at least partially overlap with the turn-on period of the auxiliary threshold compensation module 14, and thus in the threshold compensation phase Z1 and/or the reset phase Z0, the first voltage V1 can be transmitted to the fourth node N4 through the turned-on auxiliary threshold compensation module 14 and the light-emitting control module 15, so as to reset the first electrode of the light-emitting device 02.

At the same time, the first voltage V1 can also be transmitted to the third node N3 through the auxiliary threshold compensation module 14 in the threshold compensation phase Z1 and/or the reset phase Z0, thereby be beneficial to transmission to the second node N2 through the driving transistor Td and the threshold compensation module 12 in the threshold compensation phase Z1, to compensate the threshold voltage of the driving transistor Td to the gate of the driving transistor Td.

In addition, making the turn-on period of the light-emitting control module 15 does not overlap with the turn-on period of the power supply voltage writing module 11 in the reset phase Z0 and the threshold compensation phase Z1 can preventing the light-emitting control module 15 and the power supply voltage writing module 11 from forming a path, which could otherwise cause the light-emitting device 02 to emit light abnormally.

As shown in conjunction with FIGS. 9 and 10, in an implementation of the embodiment of the present disclosure, the reset phase Z0 includes a first reset sub-phase Z01 and a second reset sub-phase Z02, and the second reset sub-phase Z02 is performed after the first reset sub-phase Z01.

The light-emitting control module 15 is turned on in the first reset sub-phase Z01 and turned off in the second reset sub-phase Z02. The power supply voltage writing module 11 is turned off in the first reset sub-phase Z01 and turned on in the second reset sub-phase Z02. The threshold compensation module 12 is turned on in the second reset sub-phase Z02. The threshold compensation module 12 may be turned on or off in the first reset sub-phase Z01.

As an example, as shown in conjunction with FIGS. 9 and 10, in the first reset sub-phase Z01, the first light-emitting control signal line EM1 and the second scan line G2 each transmit a low-level signal, and the power supply voltage writing transistor T1 and the threshold compensation transistor T3 are turned off. The second light-emitting control signal line EM2 and the third scan line G3 each transmit a high-level signal. The light-emitting control transistor T5 and the auxiliary transistor T4 are turned on. The first voltage V1 can be transmitted to the third node N3 through the turned-on auxiliary transistor T4, and transmitted to the fourth node N4 through the turned-on light-emitting control transistor T5 to complete the reset of the first electrode of the light-emitting device.

In the second reset sub-phase Z02, the second light-emitting control signal line EM2 transmits a low-level signal, and the light-emitting control transistor T5 is turned off. The third scan line G3 transmits a high-level signal, the auxiliary transistor T4 is turned on. The first voltage V1 is transmitted to the third node N3 through the auxiliary transistor T4. The first light-emitting control signal line EM1 and the second scan line G2 each transmit a high-level signal, the power supply voltage writing transistor T1 and the threshold compensation transistor T3 are turned on, and the power supply voltage PVDD is transmitted to the first node N1 through the turned-on power supply voltage writing transistor T1 and is transmitted to the second node N2 through the turned-on threshold compensation transistor T3, to complete the reset of the gate of the driving transistor Td.

Optionally, as shown in conjunction with FIGS. 9 and 10, the auxiliary threshold compensation module 14 is turned on in both the reset phase Z0 and the threshold compensation phase Z1. The light-emitting control module 15 is turned off in both the threshold compensation phase Z1 and the data writing phase Z2.

Based on this arrangement, the second light-emitting control signal line EM2 electrically connected to the light-emitting control module 15 can transmit a low level in the second reset sub-phase Z02, the threshold compensation phase Z1, and the data writing phase Z2 after transmitting the high level in the first reset sub-phase Z01, which is beneficial to reducing the power consumption.

At the same time, making the auxiliary threshold compensation module 14 turned on in both the reset phase Z0 and the threshold compensation phase Z1 is beneficial to improving the accuracy of transmitting the first voltage V1 to the third node N3, and in turn is beneficial to improving the reliability of writing the first voltage V1 into the second node N2 in the threshold compensation phase Z1.

Certainly, in the data writing phase Z2, the auxiliary threshold compensation module 14 is turned off to avoid affecting the writing of the data voltage Vdata into the third node N3.

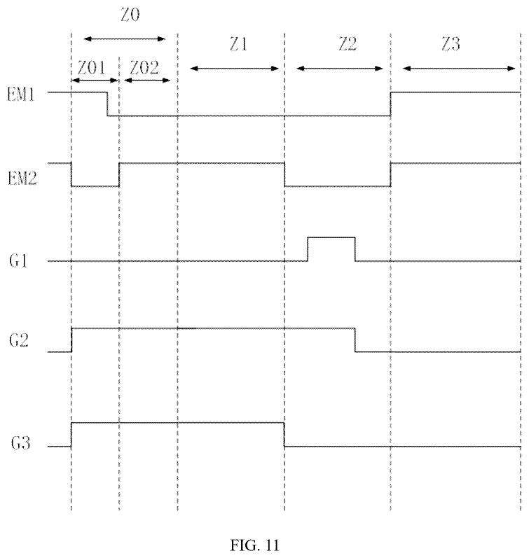

FIG. 11 is another timing diagram of the pixel circuit shown in FIG. 9.

In another implementation of the embodiment of the present disclosure, as shown in conjunction with FIGS. 9 and 11, the reset phase Z0 includes a first reset sub-phase Z01 and a second reset sub-phase Z02, and the second reset sub-phase Z02 is performed after the first reset sub-phase Z01.

The light-emitting control module 15 is turned off in the first reset sub-phase Z01 and turned on in the second reset sub-phase Z02. The power supply voltage writing module 11 is turned on in the first reset sub-phase Z01 and turned off in the second reset sub-phase Z02. The threshold compensation module 12 is turned on in the first reset sub-phase Z01. The threshold compensation module 12 may be turned on or off in the first reset sub-phase Z01.

As an example, as shown in FIGS. 9 and 11, in the first reset sub-phase Z01, the second light-emitting control signal line EM2 transmits a low-level signal, and the light-emitting control transistor T5 is turned off. The third scan line G3 transmits a high-level signal, the auxiliary transistor T4 is turned on, and the first voltage V1 is transmitted to the third node N3 through the auxiliary transistor T4. The first light-emitting control signal line EM1 and the second scan line G2 each transmit a high-level signal, the power supply voltage writing transistor T1 and the threshold compensation transistor T3 are turned on, and the power supply voltage PVDD is transmitted to the first node N1 through the turned-on power supply voltage writing transistor T1 and is transmitted to the second node N2 through the turned-on threshold compensation transistor T3, to complete the reset of the gate of the driving transistor Td.

In the second reset sub-phase Z02, the first light-emitting control signal line EM1 transmits a low-level signal, and the power supply voltage writing transistor T1 is turned off. The second light-emitting control signal line EM2 and the third scan line G3 each transmit a high-level signal, the light-emitting control transistor T5 and the auxiliary transistor T4 are turned on, and the first voltage V1 can be transmitted to the third node N3 through the turned-on auxiliary transistor T4 and transmitted to the fourth node N4 through the turned-on light-emitting control transistor T5, to complete the reset of the first electrode of the light-emitting device 02.

At the same time, the second scan line G2 transmits a high-level signal, the threshold compensation transistor T3 is turned on, the first voltage V1 is transmitted to the second node N2 through the turned-on driving transistor Td and threshold compensation transistor T3, and the threshold voltage Vth of the driving transistor Td is compensated to the gate of the driving transistor Td, which is beneficial to further increasing the compensation duration of the threshold voltage of the driving transistor Td.

Optionally, as shown in FIGS. 9 and 11, the auxiliary threshold compensation module 14 is turned on in the reset phase Z0 and the threshold compensation phase Z1, and the light-emitting control module 15 is turned on in the threshold compensation phase Z1 and turned off in the data writing phase Z2.

Based on this arrangement, in the threshold compensation phase Z1, the first voltage V1 can also be transmitted to the fourth node N4 through the turned-on auxiliary threshold compensation module 14 and the light-emitting control module 15, which is beneficial to increasing the reset duration of the first voltage V1 on the first electrode of the light-emitting device 02, thereby being beneficial to improving the reset effect of the first voltage V1 on the first electrode of the light-emitting device 02.

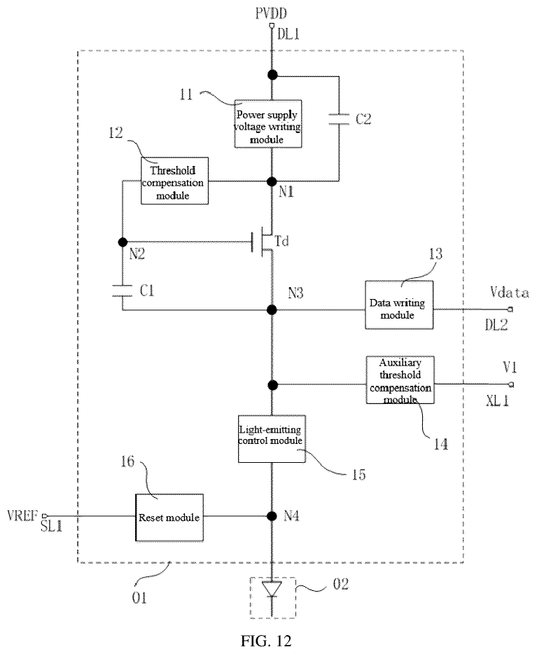

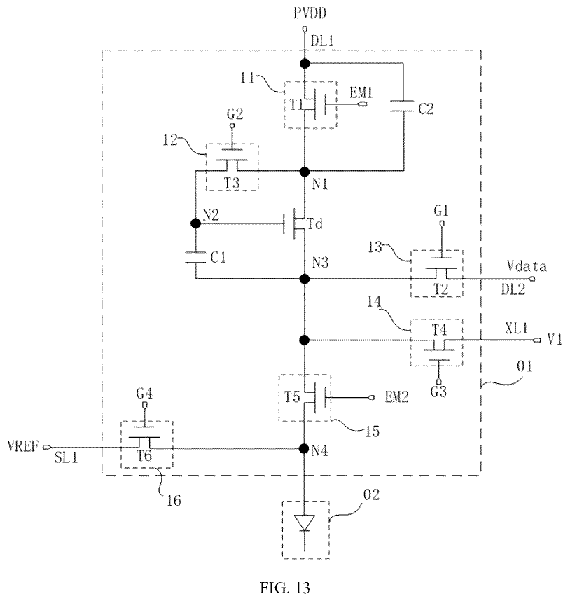

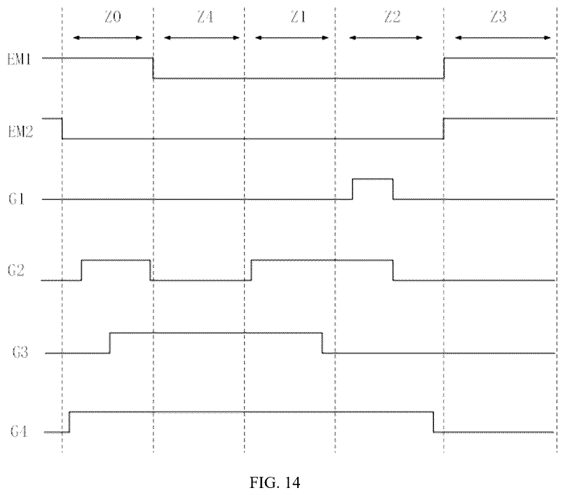

FIG. 12 is a schematic diagram of another pixel circuit according to an embodiment of the present disclosure, FIG. 13 is a schematic diagram of the pixel circuit shown in FIG. 12, and FIG. 14 is a timing diagram of the pixel circuit shown in FIG. 13.

In an embodiment of the present disclosure, as shown in FIG. 12, the pixel circuit 01 further includes a light-emitting control module 15. The light-emitting control module 15 has an input terminal electrically connected to the third node N3 and an output terminal electrically connected to the fourth node N4. The fourth node N4 is electrically connected to a first electrode of a light-emitting device 02. The light-emitting device 02 may be an organic light-emitting diode. The first electrode of the light-emitting device 02 may be an anode thereof.

As an example, as shown in FIG. 13, the light-emitting control module15 includes a light-emitting control transistor T5. The light-emitting control transistor T5 has a first electrode electrically connected to the third node N3, a second electrode electrically connected to the fourth node N4, and a gate electrically connected to the second light-emitting control signal line EM2. The light-emitting control transistor T5 may be an N-type transistor (turned on at a high level, and turned off at a low level).

The output terminal of the auxiliary threshold compensation module 14 is electrically connected to the third node N3. As shown in conjunction with FIG. 14, the operation process of the pixel circuit 01 further includes an adjustment phase Z4, which is performed between the reset phase Z0 and the threshold compensation phase Z1.

The auxiliary threshold compensation module 14 is turned on in the adjustment phase Z4 and the threshold compensation phase Z1. The first voltage V1 can also be configured to adjust a bias state of the driving transistor Td. That is, in the adjustment phase Z4, the first voltage V1 may also be used as an adjustment voltage for adjusting the bias state of the driving transistor Td.

Specifically, as shown in conjunction with FIGS. 13 and 14, in the adjustment phase Z4, the third scan line G3 transmits a high-level signal, and the first scan line G1, the second scan line G2, the first light-emitting control signal line EM1, and the second light-emitting control signal line EM2 each transmit a low-level signal. The auxiliary transistor T4 is turned on. The power supply voltage writing transistor T1, the data writing transistor T2, the threshold compensation transistor T3, and the light-emitting control transistor T5 are turned off. The first voltage V1 is transmitted to the third node N3 through the turned-on auxiliary transistor T4, to adjust the bias state of the driving transistor Td.

In the threshold compensation phase Z1, the third scan line G3 and the second scan line G2 each transmit a high-level signal. The auxiliary transistor T4 and the threshold compensation transistor T3 are turned on. The first voltage V1 is transmitted to the first node N1 through the driving transistor Td and is transmitted to the second node N2 through the threshold compensation transistor T3, until the potential of the second node N2 is V1+Vth, where Vth is the threshold voltage of the driving transistor Td, thereby compensating the threshold voltage Vth of the driving transistor Td to the gate of the driving transistor Td.

In the embodiment of the present disclosure, the first voltage V1 can be configured not only to adjust the bias state of the driving transistor Td, but also to capture the threshold voltage of the driving transistor Td in the process of being written into the second node N2, which is beneficial to reducing the structural complexity of the pixel circuit 01.

Still referring to FIG. 12, in an embodiment of the present disclosure, the pixel circuit 01 further includes a reset module 16. The reset module 16 has an input terminal electrically connected to a reset signal line SL1 and an output terminal electrically connected to the fourth node N4. The reset module 16 is configured to transmit a reset voltage VREF on the reset signal line SL1 to the fourth node N4, so as to reset the first electrode of the light-emitting device 02.

As an example, as shown in FIG. 13, the reset module 16 includes a reset transistor T6. The reset transistor T6 has a first electrode electrically connected to the reset signal line SL1, a second electrode electrically connected to the fourth node N4, and a gate electrically connected to a fourth scan line G4. The reset transistor T6 may be an N-type transistor (turned on at a high level, and turned off at a low level).

As shown in conjunction with FIG. 14, the reset module 16 is turned on in the reset phase Z0, the adjustment phase Z4, the threshold compensation phase Z1, and the data writing phase Z2.

In this way, the reset voltage VREF can be transmitted to the fourth node N4 in the reset phase Z0, the adjustment phase Z4, the threshold compensation phase Z1, and the data writing phase Z2, which is beneficial to improving the reset effect of the reset voltage VREF on the first electrode of the light-emitting device 02.

Optionally, as shown in conjunction with FIGS. 13 and 14, the light-emitting control module 15 is turned off in the reset phase Z0, the adjustment phase Z4, the threshold compensation phase Z1, and the data writing phase Z2. This is beneficial to avoiding abnormal light-emitting of the light-emitting device 02 in a non-light-emitting phase.

Optionally, as shown in conjunction with FIGS. 13 and 14, the auxiliary threshold compensation module 14 is turned on in the reset phase Z0. That is to say, in addition to being turned on in the adjustment phase Z4 and the threshold compensation phase Z1, the auxiliary threshold compensation module 14 can be turned on in the reset phase Z0. In this way, the first voltage V1 can be transmitted to the third node N3 as early as the reset phase Z0, which is beneficial to increasing the duration in which the bias state of the driving transistor Td is adjusted by the first voltage V1, thereby being beneficial to improving the effect of adjusting the bias of the driving transistor Td.

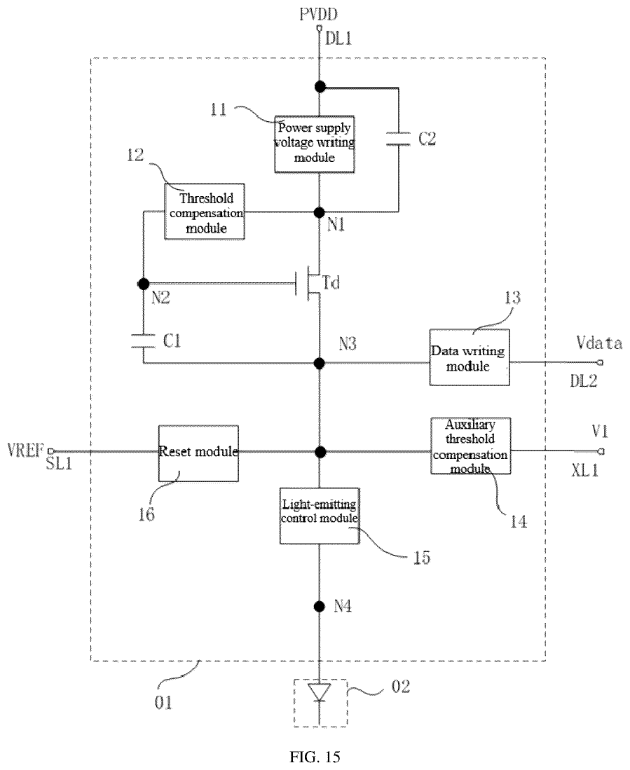

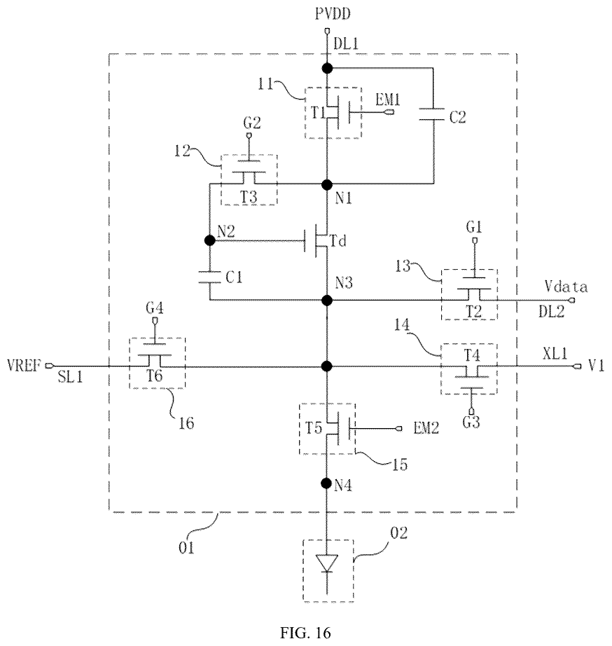

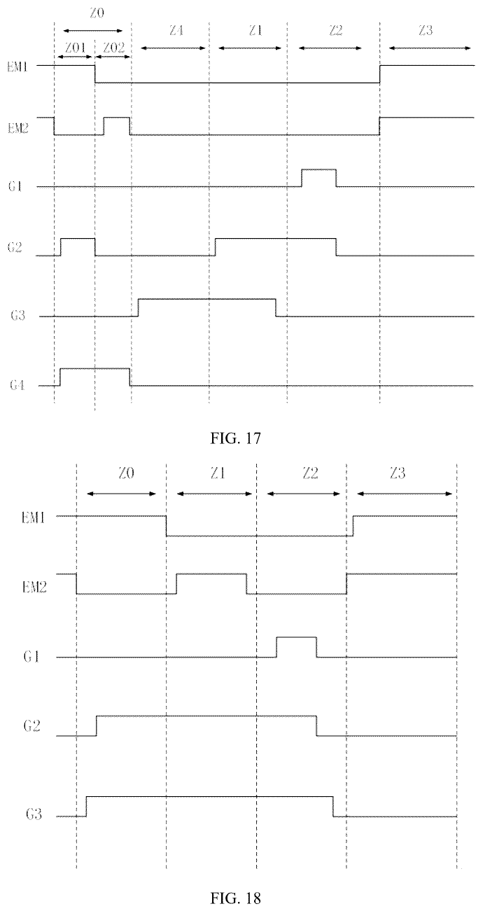

FIG. 15 is a schematic diagram of another pixel circuit according to an embodiment of the present disclosure, FIG. 16 is a schematic diagram of the pixel circuit shown in FIG. 15, and FIG. 17 is a timing diagram of the pixel circuit shown in FIG. 16.

In an embodiment of the present disclosure, as shown in FIG. 15, the pixel circuit 01 further includes a reset module 16. The reset module 16 has an input terminal electrically connected to a reset signal line SL1 and an output terminal electrically connected to the third node N3. The reset module 16 is configured to transmit a reset voltage VREF on the reset signal line SL1 to the third node N3, and the reset voltage VREF is configured to reset the first electrode of the light-emitting device 02.

As an example, as shown in FIG. 16, the reset module 16 includes a reset transistor T6. The reset transistor T6 has a first electrode electrically connected to the reset signal line SL1, a second electrode electrically connected to the third node N3, and a gate electrically connected to the fourth scan line G4. The reset transistor T6 may be an N-type transistor (turned on at a high level, and turned off at a low level).

As shown in conjunction with FIG. 17, the reset module 16 is turned on in the reset phase Z0. Moreover, in the reset phase Z0, a turn-on period of the light-emitting control module 15 at least partially overlaps with a turn-on period of the reset module 16, and the turn-on period of the light-emitting control module 15 does not overlap with a turn-on period of the power supply voltage writing module 11.

As an example, as shown in conjunction with FIGS. 16 and 17, the reset phase Z0 includes a first reset sub-phase Z01 and a second reset sub-phase Z02, and the second reset sub-phase Z02 is performed after the first reset sub-phase Z01.

In the first reset sub-phase Z01, the second light-emitting control signal line EM2, the first scan line G1, and the third scan line G3 each transmit a low-level signal, and the data writing transistor T2, the auxiliary transistor T4, and the light-emitting control transistor T5 are turned off. The first light-emitting control signal line EM1 and the second scan line G2 each transmit a high-level signal, the power supply voltage writing transistor T1 and the threshold compensation transistor T3 are turned on, and the power supply voltage PVDD is transmitted to the second node N2 through the turned-on power supply voltage writing transistor T1 and the threshold compensation transistor T3, so as to complete the reset of the gate of the driving transistor Td.

In the second reset sub-phase Z02, the first light-emitting control signal line EM1, the second scan line G2, the first scan line G1, and the third scan line G3 each transmit a low-level signal, and the power supply voltage writing transistor T1, the threshold compensation transistor T3, the data writing transistor T2, and the auxiliary transistor T4 are turned off. The second light-emitting control signal line EM2 and the fourth scan line G4 each transmit a high-level signal, the light-emitting control transistor T5 and the reset transistor T6 are turned on, and the reset voltage VREF is transmitted to the fourth node N4 through the turned-on reset transistor T6 and light-emitting control transistor T5, so as to reset the first electrode of the light-emitting device 02.

In addition, in the first reset sub-phase Z01, the fourth scan line G4 can also transmit a high-level signal to control the reset transistor T6 to be turned on. The reset voltage VREF can be transmitted to the third node N3 as early as the first reset sub-phase Z01. This is beneficial to pre-writing the reset voltage VREF into the third node N3, thereby improving the effect of resetting the first electrode of the light-emitting device 02.

Optionally, as shown in conjunction with FIGS. 16 and 17, the light-emitting control module 15 is turned off in the adjustment phase Z4, the threshold compensation phase Z1, and the data writing phase Z2. This is beneficial to avoiding abnormal light-emitting of the light-emitting device 02 in a non-light-emitting phase.

FIG. 18 is another timing diagram of the pixel circuit shown in FIG. 5.

In an embodiment of the present disclosure, as shown in FIG. 4, the pixel circuit 01 further includes a light-emitting control module 15. The light-emitting control module 15 has an input terminal electrically connected to the third node N3 and an output terminal electrically connected to a fourth node N4. The fourth node N4 is electrically connected to a first electrode of a light-emitting device 02. The light-emitting device 02 may be an organic light-emitting diode. The first electrode of the light-emitting device 02 may be an anode thereof.

As an example, as shown in FIG. 5, the light-emitting control module15 includes a light-emitting control transistor T5. The light-emitting control transistor T5 has a first electrode electrically connected to the third node N3, a second electrode electrically connected to the fourth node N4, and a gate electrically connected to the second light-emitting control signal line EM2. The light-emitting control transistor T5 may be an N-type transistor (turned on at a high level, and turned off at a low level).

As shown in FIG. 7 and FIG. 18, the operation process of the pixel circuit 01 further includes a light-emitting phase Z3 performed after the data writing phase Z2. In the light-emitting phase Z3, the power supply voltage writing module 11 and the light-emitting control module 15 are turned on, and a moment when the light-emitting control module 15 is turned on is not later than a moment when the power supply voltage writing module 11 is turned on.

As an example, as shown in FIG. 7, in the light-emitting phase Z3, the moment when the light-emitting control module 15 is turned on is the same as the moment when the power supply voltage writing module is turned on. That is, in the light-emitting phase Z3, the moment when the first light-emitting control signal line EM1 starts to transmit a high level may be the same as the moment when the second light-emitting control signal line EM2 starts to transmit a high level.

As an example, as shown in FIG. 18, in the light-emitting phase Z3, the moment when the light-emitting control module 15 is turned on is earlier than the moment when the power supply voltage writing module is turned on. That is, in the light-emitting phase Z3, the moment when the second light-emitting control signal line EM2 starts to transmit a high level may be earlier than the moment when the first light-emitting control signal line EM1 starts to transmit a high level.

As can be seen from the above-mentioned operation process of the pixel circuit 01, in the light-emitting phase Z3, the light-emitting driving current generated by the driving transistor Td can be transmitted to the light-emitting device 02 through the light-emitting control module 15, so as to drive the light-emitting device 02 to emit light.

In the embodiment of the present disclosure, the moment when the light-emitting control module 15 is turned on is set to be not later than the moment when the power supply voltage writing module 11 is turned on, that is, the moment when the power supply voltage writing module 11 is turned on is not earlier than the moment when the light-emitting control module 15 is turned on, which is beneficial to avoiding a case where after the power supply voltage writing module 11 is turned on first, the potential accumulated at the third node N3 is caused to be relatively high, and after the light-emitting control module 15 is turned on later, the high potential of the third node N3 impacts the first electrode of the light-emitting device 02, thereby being beneficial to improving the service life of the light-emitting device 02.

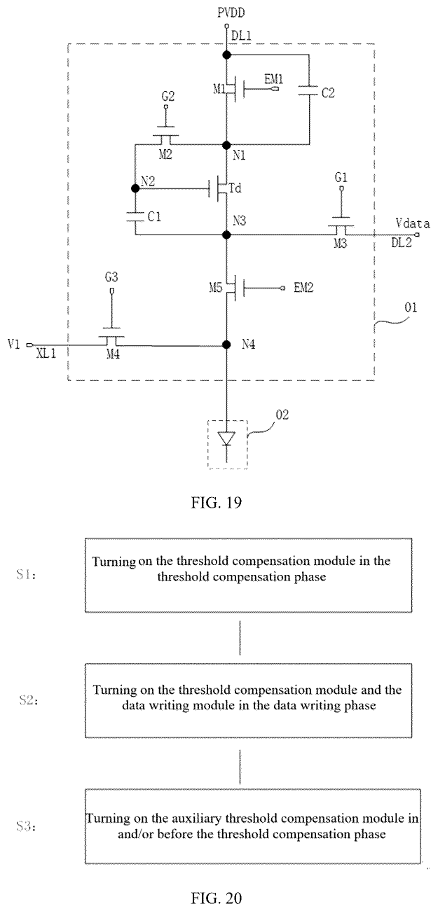

FIG. 19 is a schematic diagram of another pixel circuit according to an embodiment of the present disclosure.

The embodiment of the present disclosure further provides a pixel circuit 01 applicable to the display panel. As shown in FIG. 19, the pixel circuit 01 includes a driving transistor Td, a first transistor M1, a second transistor M2, a third transistor M3, and a fourth transistor M4. The driving transistor Td is configured to transmit a light-emitting driving current. The driving transistor Td has a first electrode electrically connected to a first node N1, a gate electrically connected to a second node N2, and a second electrode electrically connected to a third node N3. The driving transistor Td is an N-type transistor.

The first transistor M1 has a first electrode electrically connected to a power supply signal line DL1, a second electrode electrically connected to the first node N1, and a gate electrically connected to a first light-emitting control signal line EM1. The power supply signal line DL1 can be configured to transmit a power supply voltage PVDD to the first transistor M1. The third transistor M3 has a first electrode electrically connected to a data signal line DL2, a second electrode electrically connected to the third node N3, and a gate electrically connected to a first scan line G1. The data signal line DL2 can be configured to transmit a data voltage Vdata to the third transistor M3.

The second transistor M2 has a first electrode electrically connected to the first node N1, a second electrode electrically connected to the second node N2, and a gate electrically connected to a second scan line G2. The fourth transistor M4 has a first electrode electrically connected to a first signal line XL1, a second electrode coupled to the third node N3, and a gate electrically connected to a third scan line G3. The fourth transistor M4 is configured to transmit a first voltage V1 on the first signal line XL1 to the third node N3.

The timing diagram of the pixel circuit shown in FIG. 19 may be that is shown in FIG. 7, and an operation process of the pixel circuit 01 includes a threshold compensation phase Z1 and a data writing phase Z2 performed after the threshold compensation phase Z1.

The second transistor M2 is turned on in the threshold compensation phase Z1 and the data writing phase Z2. The third transistor M3 is turned on in the data writing phase Z2. The fourth transistor M4 transmits the first voltage V1 to the third node N3 during or before the threshold compensation phase Z1.

In the embodiment of the present disclosure, the threshold compensation phase Z1 and the data writing phase Z2 may be separately performed, by making the fourth transistor M4 transmit the first voltage V1 to the third node N3 during or before the threshold compensation phase Z1, the first voltage V1 can be enabled to be transmitted to the gate of the driving transistor Td through the driving transistor Td and the turned-on second transistor M2 in the threshold compensation phase Z1, thereby compensating a threshold voltage of the driving transistor Td to the gate of the driving transistor Td.

In this way, a compensation duration of the threshold voltage of the driving transistor Td is no longer limited by a writing duration of the data voltage Vdata, which is beneficial to completely compensating the threshold voltage of the driving transistor Td in the operation process of the pixel circuit 01, thereby being beneficial to eliminating the influence of the threshold voltage of the driving transistor Td on the light-emitting driving current to a relatively large extent, and in turn being beneficial to improving the brightness uniformity of different light-emitting devices 02.

In addition, as shown in FIG. 19, the pixel circuit 01 further includes a fifth transistor M5, a first capacitor C1, and a second capacitor C2. The fifth transistor M5 has a first electrode electrically connected to the third node N3, a second electrode electrically connected to a fourth node N4, and a gate electrically connected to a second light-emitting control signal line EM2. The fourth node N4 is electrically connected to a first electrode of a light-emitting device 02. The light-emitting device 02 may be an organic light-emitting diode. The first electrode of the light-emitting device 02 may be an anode thereof.

The first capacitor C1 has one plate electrically connected to the second node N2 and the other plate electrically connected to the third node N3. The second capacitor C2 has one plate electrically connected to the power supply signal line DL1 and the other plate electrically connected to the first node N1.

As an example, as shown in FIG. 19, the second electrode of the fourth transistor M4 is electrically connected to the fourth node N4, and the first voltage V1 can also be configured to reset the first electrode of the light-emitting device 02. The driving transistor Td, the first transistor M1, the second transistor M2, the third transistor M3, the fourth transistor M4, and the fifth transistor M5 may all be N-type transistors.

The operation process of the pixel circuit shown in FIG. 19 may be substantially the same as the operation process of the pixel circuit shown in FIG. 5, and details are not described herein again.

An embodiment of the present disclosure further provides a method for driving a pixel circuit 01 for driving the pixel circuit 01 according to any of the above-mentioned embodiments. As shown in FIGS. 4, 5, 8, 9, 12, 13, 15 and 16, the pixel circuit 01 includes a driving transistor Td, a power supply voltage writing module 11, a threshold compensation module 12, a data writing module 13, and an auxiliary threshold compensation module 14. The driving transistor Td is configured to generate a light-emitting driving current. The driving transistor Td has a first electrode electrically connected to a first node N1, a gate electrically connected to a second node N2, and a second electrode electrically connected to a third node N3. The driving transistor Td may be an N-type transistor. As an example, the driving transistor Td includes an oxide.

The power supply voltage writing module 11 has an input terminal electrically connected to a power supply signal line DL1 and an output terminal electrically connected to the first node N1. The power supply signal line DL1 is configured to transmit a power supply voltage PVDD to the power supply voltage writing module 11.

The threshold compensation module 12 has an input terminal electrically connected to the first node N1 and an output terminal electrically connected to the second node N2. The data writing module 13 has an input terminal electrically connected to a data signal line DL2 and an output terminal electrically connected to the third node N3. The data signal line DL2 is configured to transmit a data voltage Vdata to the data writing module 13.

The auxiliary threshold compensation module 14 has an input terminal electrically connected to a first signal line XL1 and an output terminal coupled to the third node N3. The auxiliary threshold compensation module 14 is configured to transmit a first voltage V1 on the first signal line XL1 to the third node N3.

As shown in FIGS. 6, 7, 10, 11, 14, 17, and 18, an operation process of the pixel circuit 01 includes a threshold compensation phase Z1 and a data writing phase Z2 performed after the threshold compensation phase Z1.

As shown in FIG. 20, which is a flowchart of a method for driving a pixel circuit according to an embodiment of the present disclosure, the driving method includes:
Step S1: turning on the threshold compensation module 12 in the threshold compensation phase Z1;
Step S2: turning on the threshold compensation module 12 and the data writing module 13 in the data writing phase Z2; and
Step S3: turning on the auxiliary threshold compensation module 14 in and/or before the threshold compensation phase Z1.

In the driving method according to the embodiment of the present disclosure, the threshold compensation phase Z1 and the data writing phase Z2 may be separately performed, making the auxiliary threshold compensation module 14 turned on and transmit the first voltage V1 to the third node N3 during or before the threshold compensation phase Z1 is beneficial for the first voltage V1 to be transmitted to the gate of the driving transistor Td through the driving transistor Td and the turned-on threshold compensation module 12 in the threshold compensation phase Z1, thereby compensating the threshold voltage of the driving transistor Td to the gate of the driving transistor Td.

In this way, a compensation duration of the threshold voltage of the driving transistor Td is no longer limited by a writing duration of the data voltage Vdata, which is beneficial to completely compensating the threshold voltage of the driving transistor Td in the operation process of the pixel circuit 01, thereby being beneficial to eliminating the influence of the threshold voltage of the driving transistor Td on the light-emitting driving current to a relatively large extent, and in turn being beneficial to improving the brightness uniformity of different light-emitting devices.

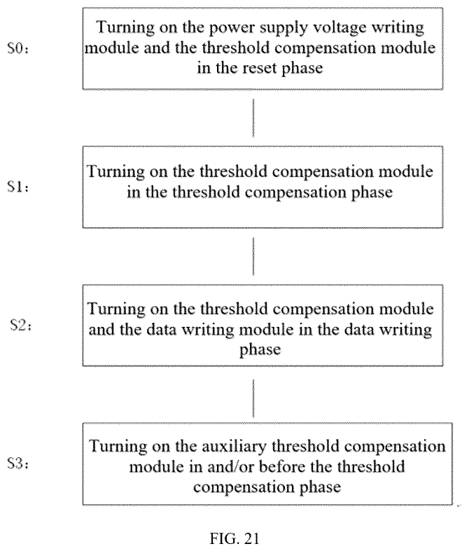

In an embodiment of the present disclosure, as shown in conjunction with FIGS. 5 and 7, the operation process of the pixel circuit 01 further includes a reset phase Z0, which is performed before the threshold compensation phase Z1. As shown in FIG. 21, which is a flowchart of a method for driving another pixel circuit according to an embodiment of the present disclosure, the driving method further includes.

Step S0: turning on the power supply voltage writing module 11 and the threshold compensation module 12 in the reset phase Z0, w
here Step S0 can be performed before the step S1.

In the embodiment of the present disclosure, in the reset phase Z0, the power supply voltage writing module 11 and the threshold compensation module 12 are turned on, and thus the power supply voltage PVDD can be transmitted to the second node N2 through the turned-on power supply voltage writing module 11 and threshold compensation module 12, so as to achieve the reset of the gate of the driving transistor Td.

In an implementation of the present disclosure, as shown in conjunction with FIGS. 5 and 7, the pixel circuit 01 further includes a light-emitting control module 15. The light-emitting control module 15 has an input terminal electrically connected to the third node N3 and an output terminal electrically connected to a fourth node N4. The fourth node N4 is electrically connected to a first electrode of a light-emitting device 02, and the output terminal of the auxiliary threshold compensation module 14 is electrically connected to the fourth node N4. The light-emitting device 02 may be an organic light-emitting diode, and the first electrode of the light-emitting device 02 may be an anode thereof. The driving method further includes:
turning on the auxiliary threshold compensation module 14 in the reset phase Z0, the threshold compensation phase Z1, and the data writing phase Z2; and
turning on the light-emitting control module 15 in the threshold compensation phase Z1.

Based on this arrangement, the first voltage V1 can also be configured to reset the first electrode of the light-emitting device 02, the first voltage V1 can be transmitted to the fourth node N4 in the reset phase Z0, the threshold compensation phase Z1, and the data writing phase Z2, which is beneficial to increasing the reset duration of the first voltage V1 on the first electrode of the light-emitting device 02, thereby being beneficial to improving the reset effect of the first voltage V1 on the first electrode of the light-emitting device 02.

Moreover, in the threshold compensation phase Z1, the first voltage V1 can be transmitted to the third node N3 through the turned-on auxiliary threshold compensation module 14 and light-emitting control module 15, and transmitted to the second node N2 through the driving transistor Td and the threshold compensation module 12, so as to compensate the threshold voltage of the driving transistor Td to the gate of the driving transistor Td.

In another implementation of the present disclosure, as shown in conjunction with FIGS. 9 and 10, the pixel circuit 01 further includes a light-emitting control module 15. The light-emitting control module 15 has an input terminal electrically connected to the third node N3 and an output terminal electrically connected to a fourth node N4. The fourth node N4 is electrically connected to a first electrode of a light-emitting device 02, and the output terminal of the auxiliary threshold compensation module 14 is electrically connected to the third node N3. The light-emitting device 02 may be an organic light-emitting diode, and the first electrode of the light-emitting device 02 may be an anode thereof. The driving method further includes:
turning on the auxiliary threshold compensation module 14 in the reset phase Z0 and the threshold compensation phase Z1; and
turning on the light-emitting control module 15 in the reset phase Z0, and a turn-on period of light-emitting control module 15 does not overlap with a turn-on period of the power supply voltage writing module 11.

Based on this arrangement, the first voltage V1 can also be configured to reset the first electrode of the light-emitting device 02. In the reset phase Z0, the first voltage V1 can be transmitted to the fourth node N4 through the turned-on auxiliary threshold compensation module 14 and light-emitting control module 15, so as to achieve the reset of the first electrode of the light-emitting device 02.

Moreover, in the threshold compensation phase Z1, the first voltage V1 can be transmitted to the third node N3 through the turned-on auxiliary threshold compensation module 14, and transmitted to the second node N2 through the driving transistor Td and the threshold compensation module 12, so as to compensate the threshold voltage of the driving transistor Td to the gate of the driving transistor Td.

In an embodiment of the present disclosure, as shown in conjunction with FIGS. 13 and 14, the pixel circuit 01 further includes a light-emitting control module 15. The light-emitting control module 15 has an input terminal electrically connected to the third node N3, an output terminal electrically connected to a fourth node N4. The fourth node N4 is electrically connected to a first electrode of a light-emitting device 02, and the output terminal of the auxiliary threshold compensation module 14 is electrically connected to the third node N3. The light-emitting device 02 may be an organic light-emitting diode, and the first electrode of the light-emitting device 02 may be an anode thereof.

The operation process of the pixel circuit 01 further includes an adjustment phase Z4. The adjustment phase Z4 is performed between the reset phase Z0 and the threshold compensation phase Z1. The driving method further includes:
turning on the auxiliary threshold compensation module 14 in the adjustment phase Z4 and the threshold compensation phase Z1.

In the embodiment of the present disclosure, the first voltage V1 can also be configured to adjust a bias state of the driving transistor Td. In the adjustment phase Z4, the first voltage V1 can be transmitted to the third node N3 through the turned-on auxiliary threshold compensation module to adjust the bias state of the driving transistor Td.

Moreover, in the threshold compensation phase Z1, the first voltage V1 can be transmitted to the third node N3 through the turned-on auxiliary threshold compensation module 14, and transmitted to the second node N2 through the driving transistor Td and the threshold compensation module 12, so as to compensate the threshold voltage of the driving transistor Td to the gate of the driving transistor Td.

In an implementation of this embodiment of the present disclosure, as shown in conjunction with FIGS. 13 and 14, the pixel circuit 01 further includes a reset module 16. The reset module 16 has an input terminal electrically connected to a reset signal line SL1 and an output terminal electrically connected to the fourth node N4. The reset module 16 is configured to transmit a reset voltage VREF on the reset signal line SL1 to the fourth node N4, so as to reset a first electrode of a light-emitting device 02. The driving method further includes:
turning on the reset module 16 in the reset phase Z0, the adjustment phase Z4, the threshold compensation phase Z1, and the data writing phase Z2.

Based on this arrangement, the reset voltage VREF can be transmitted to the fourth node N4 in the reset phase Z0, the adjustment phase Z4, the threshold compensation phase Z1, and the data writing phase Z2, which is beneficial to improving the reset effect of the reset voltage VREF on the first electrode of the light-emitting device 02.

In another implementation of the embodiment of the present disclosure, as shown in conjunction with FIGS. 16 and 17, the pixel circuit 01 further includes a reset module 16. The reset module 16 has an input terminal electrically connected to a reset signal line SL1 and an output terminal electrically connected to the third node N3. The reset module 16 is configured to transmit a reset voltage VREF on a reset signal line SL1 to the third node N3, and the reset voltage VREF is configured to reset the first electrode of the light-emitting device 02. The driving method further includes:
turning on the reset module 16 in the reset phase Z0, a turn-on period of the light-emitting control module 15 at least partially overlaps with a turn-on period of the reset module 16, and the turn-on period of the light-emitting control module 15 does not overlap with a turn-on period of the power supply voltage writing module 11.

Based on this arrangement, in the reset phase Z0, the reset voltage VREF can be transmitted to the fourth node N4 through the turned-on reset module 16 and light-emitting control module 15, so as to complete the reset of the first electrode of the light-emitting device 02.

At the same time, the turn-on period of light-emitting control module 15 does not overlap with the turn-on period of the power supply voltage writing module 11 in the reset phase Z0. Therefore, it can be avoided that the power supply voltage writing module 11 forms a path with the light-emitting control module 15, which could otherwise cause the light-emitting device 02 to emit light abnormally.

An embodiment of the present disclosure further provides a display panel 10, as shown in FIG. 3, the display panel 10 includes the pixel circuit 01 according to any of the above-mentioned embodiments. As an example, the display panel 10 may be applied to an electronic device such as a mobile phone, a computer, a tablet, or a vehicle-mounted display, which is not specifically limited in the present disclosure.

In the display panel 10, the threshold compensation phase Z1 and the data writing phase Z2 may be separately performed, making the auxiliary threshold compensation module 14 transmit the first voltage V1 to the third node N3 during or before the threshold compensation phase Z1 is beneficial for the first voltage V1 to be transmitted to the gate of the driving transistor Td through the driving transistor Td and the turned-on threshold compensation module 12 in the threshold compensation phase Z1, thereby compensating the threshold voltage of the driving transistor Td to the gate of the driving transistor Td.

In this way, a compensation duration of the threshold voltage of the driving transistor Td is no longer limited by a writing duration of the data voltage Vdata, which is beneficial to completely compensating the threshold voltage of the driving transistor Td in the operation process of the pixel circuit 01, thereby being beneficial to eliminating the influence of the threshold voltage of the driving transistor Td on the light-emitting driving current to a relatively large extent, and in turn being beneficial to improving the brightness uniformity of different light-emitting devices, thereby improving the brightness uniformity of the display panel 10.

The above are merely preferred embodiments of the present disclosure and are not intended to limit the present disclosure. Any modifications, equivalent substitutions, improvements, and the like made within the spirit and principle of the present disclosure shall fall within the protection scope of the present disclosure.

What is claimed is:

1. A pixel circuit applied to a display panel, wherein the pixel circuit comprises:
a driving transistor configured to generate a light-emitting driving current and having a first electrode electrically connected to a first node, a gate electrically connected to a second node, and a second electrode electrically connected to a third node, wherein the driving transistor is an N-type transistor;
a power supply voltage writing module having an input terminal electrically connected to a power supply signal line and an output terminal electrically connected to the first node;
a threshold compensation module having an input terminal electrically connected to the first node and an output terminal electrically connected to the second node;
a data writing module having an input terminal electrically connected to a data signal line and an output terminal electrically connected to the third node;
an auxiliary threshold compensation module having an input terminal electrically connected to a first signal line and an output terminal coupled to the third node, wherein the auxiliary threshold compensation module is configured to transmit a first voltage on the first signal line to the third node;
wherein an operation process of the pixel circuit comprises a threshold compensation phase and a data writing phase performed after the threshold compensation phase; and
wherein the threshold compensation module is turned on in the threshold compensation phase and the data writing phase, the data writing module is turned on in the data writing phase, and the auxiliary threshold compensation module transmits the first voltage to the third node during or before the threshold compensation phase.

2. The pixel circuit according to claim 1, further comprising a first capacitor and a second capacitor, wherein the first capacitor has one plate electrically connected to the second node and the other plate electrically connected to the third node; and the second capacitor has one plate electrically connected to the power supply signal line and the other plate electrically connected to the first node.

3. The pixel circuit according to claim 1, wherein the power supply voltage writing module comprises a power supply voltage writing transistor having a first electrode electrically connected to the power supply signal line, a second electrode electrically connected to the first node, and a gate electrically connected to a first light-emitting control signal line; and the data writing module comprises a data writing transistor having a first electrode electrically connected to the data signal line, a second electrode electrically connected to the third node, and a gate electrically connected to a first scan line; and
the threshold compensation module comprises a threshold compensation transistor having a first electrode electrically connected to the first node, a second electrode electrically connected to the second node, and a gate electrically connected to a second scan line; and the auxiliary threshold compensation module comprises an auxiliary transistor having a first electrode electrically connected to the first signal line, a second electrode coupled to the third node, and a gate electrically connected to a third scan line.

4. The pixel circuit according to claim 3, wherein the power supply voltage writing transistor, the data writing transistor, the threshold compensation transistor, and the auxiliary transistor are all N-type transistors.

5. The pixel circuit according to claim 1, wherein the operation process of the pixel circuit further comprises a reset phase, which is performed before the threshold compensation phase; and
the power supply voltage writing module and the threshold compensation module are turned on in the reset phase.

6. The pixel circuit according to claim 5, wherein in the reset phase, a turn-on period of the power supply voltage writing module at least partially overlaps with a turn-on period of the threshold compensation module.

7. The pixel circuit according to claim 5, wherein the pixel circuit further comprises a light-emitting control module having an input terminal electrically connected to the third node and an output terminal electrically connected to a fourth node, wherein the fourth node is electrically connected to a first electrode of a light-emitting device;
the output terminal of the auxiliary threshold compensation module is electrically connected to the fourth node, the auxiliary threshold compensation module is turned on in the reset phase and/or in the threshold compensation phase, and the first voltage is configured to reset the first electrode of the light-emitting device; and
in the reset phase and the threshold compensation phase, a turn-on period of the light-emitting control module at least partially overlaps with a turn-on period of the auxiliary threshold compensation module.

8. The pixel circuit according to claim 7, wherein the light-emitting control module comprises a light-emitting control transistor having a first electrode electrically connected to the third node, a second electrode electrically connected to the fourth node, and a gate electrically connected to a second light-emitting control signal line, wherein the light-emitting control transistor is an N-type transistor.

9. The pixel circuit according to claim 7, wherein the auxiliary threshold compensation module is turned on in the reset phase, the threshold compensation phase, and the data writing phase, and the light-emitting control module is turned off in the data writing phase.

10. The pixel circuit according to claim 5, wherein the pixel circuit further comprises a light-emitting control module having an input terminal electrically connected to the third node and an output terminal electrically connected to a fourth node, wherein the fourth node is electrically connected to a first electrode of a light-emitting device;
the output terminal of the auxiliary threshold compensation module is electrically connected to the third node, the auxiliary threshold compensation module is turned on in the reset phase and/or in the threshold compensation phase, and the first voltage is configured to reset the first electrode of the light-emitting device; and
in the reset phase and the threshold compensation phase, a turn-on period of the light-emitting control module at least partially overlaps with a turn-on period of the auxiliary threshold compensation module, and the turn-on period of the light-emitting control module does not overlap with a turn-on period of the power supply voltage writing module.

11. The pixel circuit according to claim 10, wherein the reset phase comprises a first reset sub-phase and a second reset sub-phase, wherein the second reset sub-phase is performed after the first reset sub-phase;
the light-emitting control module is turned on in the first reset sub-phase and turned off in the second reset sub-phase;
the power supply voltage writing module is turned off in the first reset sub-phase and turned on in the second reset sub-phase; and
the threshold compensation module is turned on in the second reset sub-phase.

12. The pixel circuit according to claim 11, wherein the auxiliary threshold compensation module is turned on in the reset phase and the threshold compensation phase, and the light-emitting control module is turned off in the threshold compensation phase and the data writing phase.

13. The pixel circuit according to claim 10, wherein the reset phase comprises a first reset sub-phase and a second reset sub-phase, wherein the second reset sub-phase is performed after the first reset sub-phase;
the light-emitting control module is turned off in the first reset sub-phase and turned on in the second reset sub-phase;
the power supply voltage writing module is turned on in the first reset sub-phase and turned off in the second reset sub-phase; and
the threshold compensation module is turned on in the first reset sub-phase.

14. The pixel circuit according to claim 13, wherein the auxiliary threshold compensation module is turned on in the reset phase and the threshold compensation phase; and
the light-emitting control module is turned on in the threshold compensation phase and turned off in the data writing phase.

15. The pixel circuit according to claim 5, wherein the pixel circuit further comprises a light-emitting control module having an input terminal electrically connected to the third node and an output terminal electrically connected to a fourth node, wherein the fourth node is electrically connected to a first electrode of a light-emitting device;
the output terminal of the auxiliary threshold compensation module is electrically connected to the third node, the operation process of the pixel circuit further comprises an adjustment phase, wherein the adjustment phase is performed between the reset phase and the threshold compensation phase; and
the auxiliary threshold compensation module is turned on in the adjustment phase and the threshold compensation phase.

16. The pixel circuit according to claim 15, further comprising a reset module having an input terminal electrically connected to a reset signal line and an output terminal electrically connected to the fourth node; and
the reset module is turned on in the reset phase, the adjustment phase, the threshold compensation phase, and the data writing phase.

17. The pixel circuit according to claim 16, wherein the reset module comprises a reset transistor having a first electrode electrically connected to the reset signal line, a second electrode electrically connected to the fourth node, and a gate electrically connected to a fourth scan line, wherein the reset transistor is an N-type transistor.

18. The pixel circuit according to claim 16, wherein the light-emitting control module is turned off in the reset phase, the adjustment phase, the threshold compensation phase, and the data writing phase.

19. The pixel circuit according to claim 15, wherein the auxiliary threshold compensation module is turned on in the reset phase.

20. The pixel circuit according to claim 15, further comprising a reset module having an input terminal electrically connected to a reset signal line and an output terminal electrically connected to the third node; and
the reset module is turned on in the reset phase, and in the reset phase, a turn-on period of the light-emitting control module at least partially overlaps with a turn-on period of the reset module, and the turn-on period of the light-emitting control module does not overlap with a turn-on period of the power supply voltage writing module.

21. The pixel circuit according to claim 20, wherein the light-emitting control module is turned off in the adjustment phase, the threshold compensation phase, and the data writing phase.

22. The pixel circuit according to claim 1, wherein the pixel circuit further comprises a light-emitting control module having an input terminal electrically connected to the third node and an output terminal electrically connected to a fourth node, wherein the fourth node is electrically connected to a first electrode of a light-emitting device; and
the operation process of the pixel circuit further comprises a light-emitting phase performed after the data writing phase, and in the light-emitting phase, the power supply voltage writing module and the light-emitting control module are turned on, and a moment when the light-emitting control module is turned on is not later than a moment when the power supply voltage writing module is turned on.

23. A pixel circuit applied to a display panel, wherein the pixel circuit comprises:
a driving transistor configured to generate a light-emitting driving current and having a first electrode electrically connected to a first node, a gate electrically connected to a second node, and a second electrode electrically connected to a third node, wherein the driving transistor is an N-type transistor;
a first transistor having a first electrode electrically connected to a power supply signal line and a second electrode electrically connected to the first node;
a second transistor having a first electrode electrically connected to the first node and a second electrode electrically connected to the second node;
a third transistor having a first electrode electrically connected to a data signal line and a second electrode electrically connected to the third node;
a fourth transistor having a first electrode electrically connected to a first signal line and a second electrode coupled to the third node, wherein the fourth transistor is configured to transmit a first voltage on the first signal line to the third node;
wherein an operation process of the pixel circuit comprises a threshold compensation phase and a data writing phase performed after the threshold compensation phase; and
wherein the second transistor is turned on in the threshold compensation phase and the data writing phase, the third transistor is turned on in the data writing phase, and the fourth transistor transmits the first voltage to the third node during or before the threshold compensation phase.

24. A method for driving a pixel circuit, wherein the pixel circuit comprises:
a driving transistor configured to generate a light-emitting driving current and having a first electrode electrically connected to a first node, a gate electrically connected to a second node, and a second electrode electrically connected to a third node, wherein the driving transistor is an N-type transistor;
a power supply voltage writing module having an input terminal electrically connected to a power supply signal line and an output terminal electrically connected to the first node;
a threshold compensation module having an input terminal electrically connected to the first node and an output terminal electrically connected to the second node;
a data writing module having an input terminal electrically connected to a data signal line and an output terminal electrically connected to the third node;
an auxiliary threshold compensation module having an input terminal electrically connected to a first signal line and an output terminal coupled to the third node, wherein the auxiliary threshold compensation module is configured to transmit a first voltage on the first signal line to the third node; and
wherein an operation process of the pixel circuit comprises a threshold compensation phase and a data writing phase performed after the threshold compensation phase; the method comprises:
turning on the threshold compensation module in the threshold compensation phase;
turning on the threshold compensation module and the data writing module in the data writing phase; and
turning on the auxiliary threshold compensation module in and/or before the threshold compensation phase.

25. The method according to claim 24, wherein the operation process of the pixel circuit further comprises a reset phase, wherein the reset phase is performed before the threshold compensation phase; and the method further comprises:
turning on the power supply voltage writing module and the threshold compensation module in the reset phase.

26. The method according to claim 25, wherein the pixel circuit further comprises a light-emitting control module having an input terminal electrically connected to the third node and an output terminal electrically connected to a fourth node, wherein the fourth node is electrically connected to a first electrode of a light-emitting device; the output terminal of the auxiliary threshold compensation module is electrically connected to the fourth node; and the method further comprises:
turning on the auxiliary threshold compensation module in the reset phase, the threshold compensation phase, and the data writing phase; and
turning on the light-emitting control module in the threshold compensation phase.

27. The method according to claim 25, wherein the pixel circuit further comprises a light-emitting control module having an input terminal electrically connected to the third node and an output terminal electrically connected to a fourth node, wherein the fourth node is electrically connected to a first electrode of a light-emitting device; the output terminal of the auxiliary threshold compensation module is electrically connected to the third node; and the method further comprises:
turning on the auxiliary threshold compensation module in the reset phase and the threshold compensation phase; and
turning on the light-emitting control module in the reset phase, and a turn-on period of the light-emitting control module does not overlap with a turn-on period of the power supply voltage writing module.

28. The method according to claim 25, wherein the pixel circuit further comprises a light-emitting control module having an input terminal electrically connected to the third node and an output terminal electrically connected to a fourth node, wherein the fourth node is electrically connected to a first electrode of a light-emitting device; and
the output terminal of the auxiliary threshold compensation module is electrically connected to the third node, and the operation process of the pixel circuit further comprises an adjustment phase, wherein the adjustment phase is performed between the reset phase and the threshold compensation phase; and the method further comprises:
turning on the auxiliary threshold compensation module in the adjustment phase and the threshold compensation phase.

29. The method according to claim 28, further comprising a reset module having an input terminal electrically connected to a reset signal line and an output terminal electrically connected to the fourth node; wherein the method further comprises:
turning on the reset module in the reset phase, the adjustment phase, the threshold compensation phase, and the data writing phase.

30. The method according to claim 28, further comprising a reset module having an input terminal electrically connected to a reset signal line and an output terminal electrically connected to the third node; wherein the method further comprises:
turning on the reset module in the reset phase, a turn-on period of the light-emitting control module at least partially overlaps with a turn-on period of the reset module, and the turn-on period of the light-emitting control module does not overlap with a turn-on period of the power supply voltage writing module.
